(19) United States
(12) Patent Application Publication
(10) Pub. No.: US 2026/0271049 A1
(43) Pub. Date: Sep. 10, 2026

(54) SCHEDULING REQUEST FORMATS IN MULTI-BIT TRANSMISSION OCCASIONS

(71) Applicant: QUALCOMM Incorporated, San Diego, CA (US)

(72) Inventors: Kangqi LIU, San Diego, CA (US); Linhai HE, San Diego, CA (US); Yi HUANG, San Diego, CA (US); Gabi SARKIS, San Diego, CA (US); Mostafa KHOSHNEVISAN, San Diego, CA (US)

(21) Appl. No.: 19/069,950

(22) Filed: Mar. 4, 2025

(51) Int. Cl. H04W 72/566; H04W 72/044; H04W 72/12

(52) U.S. Cl. CPC H04W 72/566; H04W 72/044; H04W 72/12

(57) ABSTRACT

Methods, systems, and devices for wireless communication are described. The systems, methods, and devices of this disclosure each have several innovative aspects, no single one of which is solely responsible for the desirable attributes disclosed herein. A user equipment (UE) may receive a message indicating single-bit resources associated with high-priority scheduling requests, multi-bit resources associated with low-priority scheduling requests, and formats for scheduling requests. The UE may transmit a second message indicating one or more scheduling requests over one of the multi-bit resources in accordance with one of the formats to indicate whether the one or more scheduling requests include a high-priority scheduling request. In some cases, the UE may transmit a two-bit scheduling request or a three or more bit scheduling request in accordance with the format. The UE may receive a response to the one or more scheduling requests.

### FIELD OF TECHNOLOGY

The following relates to wireless communication, including scheduling request formats in multi-bit transmission occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein. In some examples, a user equipment (UE) may receive a message indicating single-bit resources associated with high-priority scheduling requests, multi-bit resources associated with low-priority scheduling requests, and one or more formats for one or more different types of scheduling requests. The UE may transmit a second message indicating one or more scheduling requests over one of the multi-bit resources, where the UE may transmit the second message in accordance with one of the formats to indicate whether the one or more scheduling requests include a high-priority scheduling request. In some cases, the UE may transmit a two-bit scheduling request according to a two-bit format. For example, a two-bit format may involve a first bit to represent a high-priority scheduling request and a second bit to represent a low-priority scheduling request, or the first bit may indicate whether a scheduling request is present while the second bit may indicate an associated priority. Additionally, or alternatively, the UE may transmit a three or more bit scheduling request according to a larger format. In a larger format, X bits of a multi-bit scheduling request may represent a scheduling request type and an additional bit of the scheduling request may represent a priority, or Y bits may represent a scheduling request index while an additional bit may represent priority. In some cases, the UE may transmit a scheduling request including a first quantity of bits for high-priority scheduling requests and a second quantity of bits for low-priority scheduling requests, or a single quantity of bits to indicate a type of scheduling request. In some examples, the UE may implement a unified scheduling request configuration. The UE may receive a response to the one or more scheduling requests.

A method for wireless communications by a user equipment (UE) is described. The method may include receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests, transmitting a second message indicating one or more scheduling requests over a multi-bit resource of the second set of multiple resources in accordance with a format of the one or more formats, the format indicating whether the one or more scheduling requests include a high-priority scheduling request, and receiving a response to the one or more scheduling requests.

A UE for wireless communications is described. The UE may include one or more memories storing processor executable code, and one or more processors coupled with the one or more memories. The one or more processors may individually or collectively be operable to execute the code (e.g., directly, indirectly, after pre-processing, without pre-processing) to cause the UE to receive a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests, transmit a second message indicating one or more scheduling requests over a multi-bit resource of the second set of multiple resources in accordance with a format of the one or more formats, the format indicating whether the one or more scheduling requests include a high-priority scheduling request, and receive a response to the one or more scheduling requests.

Another UE for wireless communications is described. The UE may include means for receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests, means for transmitting a second message indicating one or more scheduling requests over a multi-bit resource of the second set of multiple resources in accordance with a format of the one or more formats, the format indicating whether the one or more scheduling requests include a high-priority scheduling request, and means for receiving a response to the one or more scheduling requests.

A non-transitory computer-readable medium storing code for wireless communications is described. The code may include instructions executable by one or more processors to receive a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests, transmit a second message indicating one or more scheduling requests over a multi-bit resource of the second set of multiple resources in accordance with a format of the one or more formats, the format indicating whether the one or more scheduling requests include a high-priority scheduling request, and receive a response to the one or more scheduling requests.

In some examples of the method, user equipment (UEs), and non-transitory computer-readable medium described herein, transmitting a second message may include operations, features, means, or instructions for transmitting the second message including two bits over the multi-bit resource in accordance with the format of the one or more formats, where at least one of the two bits indicates whether the second message includes a high-priority scheduling request.

In some examples of the method, user equipment (UEs), and non-transitory computer-readable medium described herein, the second message includes a first bit indicating whether the one or more scheduling requests include a high-priority scheduling request and a second bit indicating whether the one or more scheduling requests include a low-priority scheduling request.

In some examples of the method, user equipment (UEs), and non-transitory computer-readable medium described herein, the second message includes a first bit indicating a presence of a scheduling request and a second bit indicating a priority of the scheduling request.

In some examples of the method, user equipment (UEs), and non-transitory computer-readable medium described herein, transmitting a second message may include operations, features, means, or instructions for transmitting the second message including three or more bits, where at least one of the three or more bits indicates whether the second message includes a high-priority scheduling request.

In some examples of the method, user equipment (UEs), and non-transitory computer-readable medium described herein, the second message includes a quantity of bits indicating a type of a scheduling request and an additional bit indicating a priority of the scheduling request.

In some examples of the method, user equipment (UEs), and non-transitory computer-readable medium described herein, the second message includes a quantity of bits indicating an index associated with a scheduling request and an additional bit indicating a priority of the scheduling request. In some examples, a mapping for a set of multiple indexes including the index and a set of multiple scheduling requests including the scheduling request may be configured at the UE or may be received via the first message or via a third message.

In some examples of the method, user equipment (UEs), and non-transitory computer-readable medium described herein, the second message includes a first quantity of bits indicating one or more high-priority scheduling requests and a second quantity of bits indicating one or more low-priority scheduling requests.

In some examples of the method, user equipment (UEs), and non-transitory computer-readable medium described herein, the second message includes a quantity of bits indicating a type of a scheduling request and the quantity of bits may be based on a first quantity of bits for indicating one or more high-priority scheduling requests and a second quantity of bits for one or more low-priority scheduling requests.

In some examples of the method, user equipment (UEs), and non-transitory computer-readable medium described herein, the response indicates a third set of multiple resources scheduled for use in accordance with the one or more scheduling requests.

A method for wireless communications by a network entity is described. The method may include outputting a first message indicating a first set of multiple resources and a second set of multiple resources and indicating one or more formats for one or more different types of scheduling requests for one or more user equipments (UEs), the first set of multiple resources including single-bit resources associated with high-priority scheduling requests and the second set of multiple resources including multi-bit resources associated with both low-priority scheduling requests and high-priority scheduling requests, obtaining a second message indicating one or more scheduling requests over a multi-bit resource of the second set of multiple resources in accordance with a format of the one or more formats, the format indicating whether the one or more scheduling requests include a high-priority scheduling request, and outputting a response to the one or more scheduling requests.

A network entity for wireless communications is described. The network entity may include one or more memories storing processor executable code, and one or more processors coupled with the one or more memories. The one or more processors may individually or collectively be operable to execute the code (e.g., directly, indirectly, after pre-processing, without pre-processing) to cause the network entity to output a first message indicating a first set of multiple resources and a second set of multiple resources and indicating one or more formats for one or more different types of scheduling requests for one or more user equipments (UEs), the first set of multiple resources including single-bit resources associated with high-priority scheduling requests and the second set of multiple resources including multi-bit resources associated with both low-priority scheduling requests and high-priority scheduling requests, obtain a second message indicating one or more scheduling requests over a multi-bit resource of the second set of multiple resources in accordance with a format of the one or more formats, the format indicating whether the one or more scheduling requests include a high-priority scheduling request, and output a response to the one or more scheduling requests.

Another network entity for wireless communications is described. The network entity may include means for outputting a first message indicating a first set of multiple resources and a second set of multiple resources and indicating one or more formats for one or more different types of scheduling requests for one or more user equipments (UEs), the first set of multiple resources including single-bit resources associated with high-priority scheduling requests and the second set of multiple resources including multi-bit resources associated with both low-priority scheduling requests and high-priority scheduling requests, means for obtaining a second message indicating one or more scheduling requests over a multi-bit resource of the second set of multiple resources in accordance with a format of the one or more formats, the format indicating whether the one or more scheduling requests include a high-priority scheduling request, and means for outputting a response to the one or more scheduling requests.

A non-transitory computer-readable medium storing code for wireless communications is described. The code may include instructions executable by one or more processors to output a first message indicating a first set of multiple resources and a second set of multiple resources and indicating one or more formats for one or more different types of scheduling requests for one or more user equipments (UEs), the first set of multiple resources including single-bit resources associated with high-priority scheduling requests and the second set of multiple resources including multi-bit resources associated with both low-priority scheduling requests and high-priority scheduling requests, obtain a second message indicating one or more scheduling requests over a multi-bit resource of the second set of multiple resources in accordance with a format of the one or more formats, the format indicating whether the one or more scheduling requests include a high-priority scheduling request, and output a response to the one or more scheduling requests.

In some examples of the method, network entities, and non-transitory computer-readable medium described herein, obtaining a second message may include operations, features, means, or instructions for obtaining the second message including two bits over the multi-bit resource in accordance with the format of the one or more formats, where at least one of the two bits indicates whether the second message includes a high-priority scheduling request.

In some examples of the method, network entities, and non-transitory computer-readable medium described herein, the second message includes a first bit indicating whether the one or more scheduling requests include a high-priority scheduling request and a second bit indicating whether the one or more scheduling requests include a low-priority scheduling request.

In some examples of the method, network entities, and non-transitory computer-readable medium described herein, the second message includes a first bit indicating a presence of a scheduling request and a second bit indicating a priority of the scheduling request.

In some examples of the method, network entities, and non-transitory computer-readable medium described herein, obtaining a second message may include operations, features, means, or instructions for obtaining the second message including three or more bits, where at least one of the three or more bits indicates whether the second message includes a high-priority scheduling request.

In some examples of the method, network entities, and non-transitory computer-readable medium described herein, the second message includes a quantity of bits indicating a type of a scheduling request and an additional bit indicating a priority of the scheduling request.

In some examples of the method, network entities, and non-transitory computer-readable medium described herein, the second message includes a quantity of bits indicating an index associated with a scheduling request and an additional bit indicating a priority of the scheduling request. In some examples, a mapping for a set of multiple indexes including the index and a set of multiple scheduling requests including the scheduling request may be operable to be output via the first message or via a third message.

In some examples of the method, network entities, and non-transitory computer-readable medium described herein, the second message includes a first quantity of bits indicating one or more high-priority scheduling requests and a second quantity of bits indicating one or more low-priority scheduling requests.

In some examples of the method, network entities, and non-transitory computer-readable medium described herein, the second message includes a quantity of bits indicating a type of a scheduling request and the quantity of bits may be based on a first quantity of bits for indicating one or more high-priority scheduling requests and a second quantity of bits for one or more low-priority scheduling requests.

Some examples of the method, network entities, and non-transitory computer-readable medium described herein may further include operations, features, means, or instructions for scheduling a third set of multiple resources for use in accordance with the one or more scheduling requests, where the response indicates the third set of multiple resources.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports scheduling request formats in multi-bit transmission occasions in accordance with one or more aspects of the present disclosure.

FIG. 2 shows an example of a wireless communications system that supports scheduling request formats in multi-bit transmission occasions in accordance with one or more aspects of the present disclosure.

FIG. 3 shows an example of a process flow that supports scheduling request formats in multi-bit transmission occasions in accordance with one or more aspects of the present disclosure.

FIGS. 4 and 5 show block diagrams of devices that support scheduling request formats in multi-bit transmission occasions in accordance with one or more aspects of the present disclosure.

FIG. 6 shows a block diagram of a communications manager that supports scheduling request formats in multi-bit transmission occasions in accordance with one or more aspects of the present disclosure.

FIG. 7 shows a diagram of a system including a device that supports scheduling request formats in multi-bit transmission occasions in accordance with one or more aspects of the present disclosure.

FIGS. 8 and 9 show block diagrams of devices that support scheduling request formats in multi-bit transmission occasions in accordance with one or more aspects of the present disclosure.

FIG. 10 shows a block diagram of a communications manager that supports scheduling request formats in multi-bit transmission occasions in accordance with one or more aspects of the present disclosure.

FIG. 11 shows a diagram of a system including a device that supports scheduling request formats in multi-bit transmission occasions in accordance with one or more aspects of the present disclosure.

FIGS. 12 through 16 show flowcharts illustrating methods that support scheduling request formats in multi-bit transmission occasions in accordance with one or more aspects of the present disclosure.

### DETAILED DESCRIPTION

Wireless networks may support the use of scheduling requests to request scheduling of resources for various communications. Some systems may implement separate scheduling request configurations for different types, or priorities, of scheduling requests. In some examples, scheduling request configurations may implement mixed message formats to further improve efficiency in communications. For example, a user equipment (UE) may transmit a low-priority scheduling request (e.g., a scheduling request having a relatively low priority, such as a non-time sensitive scheduling request, or a scheduling request associated with low priority data or processes) using a multi-bit physical uplink control channel (PUCCH) format and may transmit a high-priority scheduling request (e.g., a scheduling request having a relatively high priority, such as a time-sensitive scheduling request, or a scheduling request associated with high priority data or processes) using a single-bit PUCCH format. In some examples, the UE may transmit a high-priority scheduling request in a next single-bit occasion, or may transmit the high-priority scheduling request in a next multi-bit occasion if the occasion precedes a next single-bit occasion. However, a high-priority scheduling request transmitted in a multi-bit occasion may lack information regarding a priority of the request and may result in ambiguity as to whether a low or high-priority scheduling request is triggered by a UE, which may reduce an efficiency of communications as well as increase a latency for high-priority messaging, among other scheduling strategy impacts.

Techniques described herein support different scheduling request formats to differentiate between high-priority and low-priority scheduling requests transmitted over a multi-bit transmission occasion. For example, a UE may receive a message indicating single-bit resources (e.g., single-bit transmission occasions) associated with high-priority scheduling requests, multi-bit resources (e.g., multi-bit transmission occasions) associated with low-priority scheduling requests, and one or more formats for different types of scheduling requests. In some examples, the UE may transmit a two-bit scheduling request according to a two-bit format. The two-bit format may involve a first bit to represent a high-priority scheduling request while a second bit may represent a low-priority scheduling request, or the first bit may indicate whether a scheduling request is present while the second bit may indicate an associated priority. Additionally, or alternatively, the UE may transmit a three or more bit scheduling request according to a larger format. In a larger format, X bits of a multi-bit scheduling request may represent a scheduling request type and an additional bit of the scheduling request may represent a priority, or Y bits may represent a scheduling request index while an additional bit may represent priority. In some cases, the UE may transmit a scheduling request including a first quantity of bits for high-priority scheduling requests and a second quantity of bits for low-priority scheduling requests, or a single quantity of bits to indicate a type of scheduling request. In some examples, the UE may implement a unified scheduling request configuration. The UE may also receive a response to the one or more scheduling requests.

In some examples, utilizing a scheduling request format to enable differentiation between high-priority or low-priority scheduling requests may remove ambiguity in a request, improving efficiency and reducing latency in communications. Additionally, or alternatively, using the scheduling request formats described herein may enable the indication of multiple different types scheduling requests, reducing overhead. Further, using a unified scheduling request configuration may reduce overhead in configuration messages, reduce a chance of failed messages, while also allowing reporting of different types of scheduling requests using the same resources, further increasing efficiency and reducing latency in communications.

Aspects of the disclosure are initially described in the context of wireless communications systems. Aspects of the disclosure are further illustrated by and described with reference to wireless communications systems and process flows that relate to scheduling request formats in multi-bit transmission occasions. Aspects of the disclosure are further illustrated by and described with reference to apparatus diagrams, system diagrams, and flowcharts that relate to scheduling request formats in multi-bit transmission occasions.

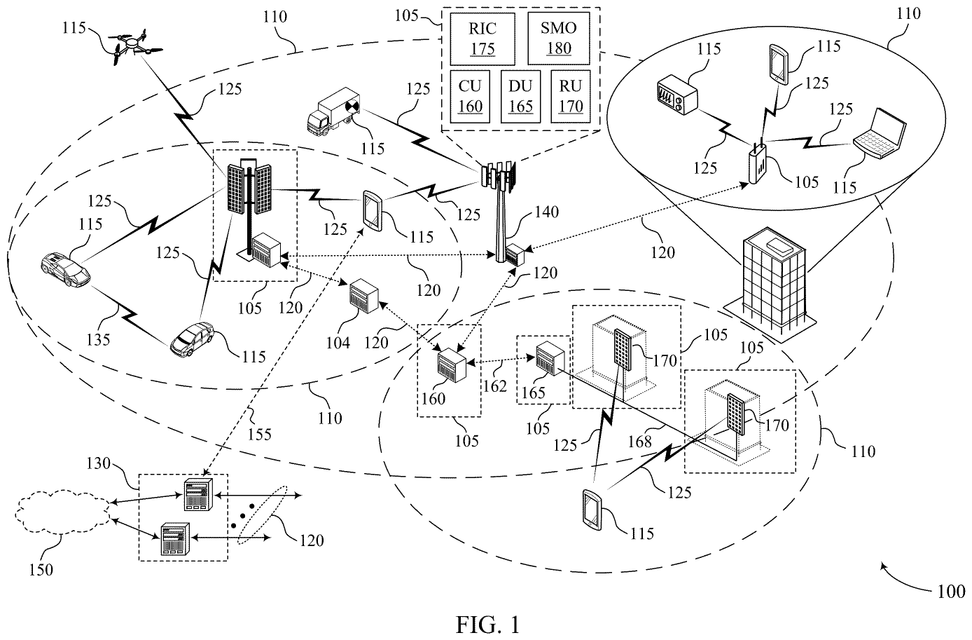

FIG. 1 shows an example of a wireless communications system 100 that supports scheduling request formats in multi-bit transmission occasions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support scheduling request formats in multi-bit transmission occasions as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, the wireless communications system 100 may support different scheduling request formats to differentiate between high-priority and low-priority scheduling requests transmitted over a multi-bit transmission occasion. For example, a may receive a message indicating single-bit resources associated with high-priority scheduling requests, multi-bit resources associated with low-priority scheduling requests, and one or more formats for different types of scheduling requests. In some examples, the UE 115 may transmit a two-bit scheduling request according to a two-bit format. The two-bit format may involve a first bit to represent a high-priority scheduling request while a second bit may represent a low-priority scheduling request, or the first bit may indicate whether a scheduling request is present while the second bit may indicate an associated priority.

Additionally, or alternatively, the UE 115 may transmit a three or more bit scheduling request according to a larger format. In a larger format, X bits of a multi-bit scheduling request may represent a scheduling request type and an additional bit of the scheduling request may represent a priority, or Y bits may represent a scheduling request index while an additional bit may represent priority. In some cases, the UE 115 may transmit a scheduling request including a first quantity of bits for high-priority scheduling requests and a second quantity of bits for low-priority scheduling requests, or a single quantity of bits to indicate a type of scheduling request. In some examples, the UE 115 may implement a unified scheduling request configuration. The UE may also receive a response to the one or more scheduling requests.

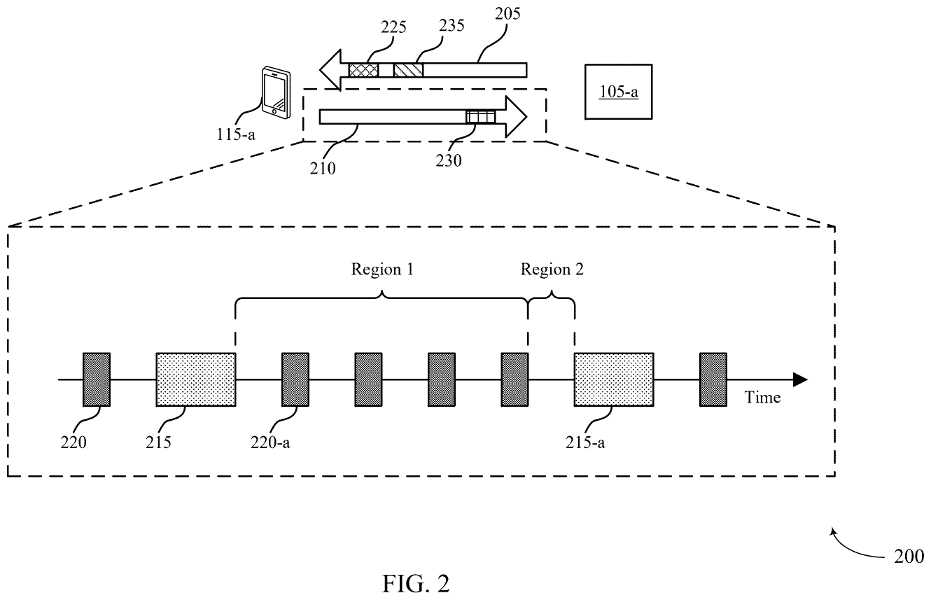

FIG. 2 shows an example of a wireless communications system 200 that supports scheduling request formats in multi-bit transmission occasions in accordance with one or more aspects of the present disclosure. In some examples, the wireless communications system 200 may implement or be implemented by aspects of the wireless communications system 100. For example, the wireless communications system 200 may include one or more UEs 115, including a UE 115-a, and one or more network entities 105, such as a network entity 105-a, which may be examples of corresponding devices described with reference to FIG. 1. In some examples, the UE 115-a may be in communication with the network entity 105-a via a downlink communication link 205 and an uplink communication link 210, which may be examples of communication link(s) 125. Further, while the methods, operations, and configurations described herein may be described with respect to a UE 115 and a network entity 105, such features may be implemented between any two devices (e.g., between two UEs 115 using a D2D communication link 135). In some examples, the one or more UEs 115 and network entities 105 may support different scheduling request formats as described herein.

In some examples, the wireless communications system 200 may implement mixed message formats (e.g., PUCCH formats), which may be more resource efficient compared to using a single message format. For example, the UE 115-a may use a multi-bit PUCCH format (e.g., format 3/4 for PUCCH) to indicate a trigger of a scheduling request (e.g., priority for data, TRP vs secondary cell (SCell) beam failure recovery (BFR), measurement gap (MG) deactivation/activation, among other examples). In some cases, multi-bit PUCCH formats may be used for low-priority scheduling requests. Additionally, or alternatively, the UE 115-a may use a single-bit PUCCH format (e.g., format 0/1 for PUCCH) for high-priority requests. For example, a UE 115 may utilize one or more scheduling request configurations defining multiple occasions 215 and occasions 220, which may represent multi-bit transmission occasions and single-bit transmission occasions in the time domain, respectively. In some cases, high-priority requests may use any occasion including both single-bit formats, such as occasions 220, and multi-bit formats, such as occasions 215.

Further, the wireless communications system 200 may use dynamic adaptation on the single-bit occasions, or occasions 220, to further improve efficiency. In some cases, dynamic adaptation may be associated with the wireless communications system 200 enabling different types of scheduling requests to utilize the same resources (e.g., PUCCH resources) or to utilize different combinations of resources (e.g., single-bit occasions may be shared among different types of scheduling requests). For example, in some systems, each type of scheduling request may be associated with a fixed PUCCH resource. In an example, a first type of scheduling request (e.g., Type 1) may be indicated (e.g., by the UE 115-a) in a first resource (e.g., Resource 1), and a second type of scheduling request (e.g., Type 2) may be indicated in a second resource (e.g., Resource 2). Another system may support dynamic adaptation, where dynamic adaption may refer to where the first type of scheduling request may also be indicated in a resource other than the first resource (e.g., may be indicated in Resource 2). By diversifying PUCCH formats, the wireless communications system 100 may mitigate wasted resources due to hard partitioning of PUCCH resources. Further, the wireless communications system 200 may use dynamic adaptation to allow single-bit occasions to be used when needed, while higher efficiency may enable the wireless communications system 200 (e.g., via the network entity 105-a) to allocate more scheduling request resources, and may result in a relatively lower scheduling latency.

In some examples, a UE 115 (e.g., the UE 115-a) may transmit a high-priority scheduling request in a next available transmission occasion. For example, when the UE 115 generates a high-priority scheduling request to be sent in a Region 1, the UE may use a next single-bit occasion 220 (e.g., a closest transmission occasion of a single-bit PUCCH format). This case may be unambiguous as to which priority of scheduling request is indicated as a single-bit occasion, such as an occasion 220-a, may be used for high-priority scheduling requests but not the low-priority scheduling requests. However, when a UE 115 generates a high-priority scheduling request to be sent in Region 2, or a low-priority scheduling request to be sent, the UE 115 may use a next multi-bit occasion, such as an occasion 215-a (e.g., a closest transmission occasion of a multi-bit PUCCH format). However, this case may present an ambiguity issue because a network entity 105 receiving the scheduling request (e.g., the network entity 105-a) may be unaware of whether a high-priority scheduling request or a low-priority scheduling request is triggered by the UE 115 during a multi-bit transmission occasion (as a multi-bit scheduling request may be used for either priority of scheduling request).

Ambiguity relating to scheduling request priority may impact a scheduling strategy of a network entity 105, which may reduce an efficiency of communications as well as increase latency for high-priority messaging, among other scheduling strategy impacts. For example, due to the ambiguity, the network entity 105 may assume a low-priority scheduling request, and may utilize a low-priority scheduling strategy even if a high-priority scheduling request is sent, which may result in added latency in scheduling, or added latency in communications due to assignment of incorrect resources. It may be useful to implement different scheduling request formats (e.g., scheduling request schemes) to differentiate between high-priority scheduling requests and low-priority scheduling requests triggered by a UE 115 in a multi-bit format.

As described herein, the wireless communications system 200 may support different scheduling request formats to differentiate between high-priority and low-priority scheduling requests transmitted over a multi-bit transmission occasion. For example, the UE 115-a may receive a message 225 from the network entity 105-a indicating resources as well as one or more formats for scheduling requests. In some examples, the message 225 may include a first set of single-bit resources for high-priority scheduling requests, including one or more occasions 220, and a second set of multi-bit resources for low-priority or high-priority scheduling requests, including one or more occasions 215. Additionally, or alternatively, the message 225 may include other types of resources (e.g., other types of single-bit or multi-bit resources) for use in scheduling requests or other communications. The UE 115-a may transmit a message 230 (or one or more messages 230) indicating one or more scheduling requests according to the indicated formats. For example, the UE 115-a may transmit the message 230 in the occasion 215-a. In some examples, the message 230 may be an example of a radio resource control (RRC) message, a MAC control element (MAC-CE) message, or another type of control message or other message. The message 225 may in some cases indicate a format to use, or the UE 115-a may select a format from those indicated in the message 225. Additionally, or alternatively, the UE 115-a may be previously configured to utilize one of the formats.

After transmitting the message 230 to indicate one or more scheduling requests, the UE 115-a may receive a response 235 from the network entity 105-a. For example, the network entity 105-a may schedule one or more resources according to a high-priority scheduling strategy, a low-priority scheduling strategy, or both, based on the one or more scheduling requests, and may indicate the scheduled resources to the UE 115-a within the response 235 (e.g., via a grant in the response 235). Additionally, or alternatively, the network entity 105-a may deny one or more scheduling requests, and may transmit an indication of the denial, or may omit transmitting a response 235. In some examples, the UE 115-a may transmit the message 230 based on having one or more scheduling requests or based on one or more triggering conditions (e.g., corresponding to a type of scheduling request).

In some examples, the formats may include one or more two-bit scheduling request formats (e.g., schemes). For example, a first format may include one bit of a two-bit scheduling request that may represent a high-priority scheduling request, and the other bit of the two-bit scheduling request may represent a low-priority scheduling request. In some cases, a bit indication of Positive+Positive (e.g., two logical ‘1’s) may indicate that the UE 115-a triggers both a high-priority scheduling request and a low-priority scheduling request. Additionally, or alternatively, a bit indication of Positive+Negative (e.g., a logical ‘1’ and a logical ‘0’) may indicate that there is a high-priority scheduling and no other scheduling requests. Other bit combinations may include Negative+Positive to indicate that there is a low-priority scheduling request and no other scheduling requests, and Negative+Negative to indicate that there are no scheduling requests. In some examples, the UE 115-a may report up to two types of scheduling requests at a time (e.g., in a same message, consecutively) by using the first format (e.g., one high-priority scheduling request and one low-priority scheduling request).

A second format may include one bit of the two-bit scheduling request that may represent whether there is a scheduling request while the other bit may represent a priority of the scheduling request. Bit combinations for the second format may include Positive+Positive to indicate that there is a high-priority scheduling request, while indication of whether there is a low-priority scheduling request is omitted, Positive+Negative to indicate that there is a low-priority scheduling request and no other scheduling requests (e.g., there is no high-priority scheduling request), and Negative+Positive/Negative (either Positive or Negative) to indicate that there is no scheduling request. In some cases, in response to a Positive+Positive indication in the message 230 (e.g., UE reports at least one high-priority scheduling request), the network entity 105-a may use a high-priority scheduling strategy for scheduling resources. In some examples, the UE 115-a may report up to one type of scheduling request at a time using the second format.

In some cases, the UE may use a grant for both the first and second format to receive resources or data for both high-priority and low-priority scheduling requests. Further, a bitmap or a table may be pre-defined or pre-configured at the UE 115-a (e.g., via RRC) to define the various bit combinations of the first and second formats. In some examples, the UE 115-a may report one or more scheduling requests according to the first format or the second format using either PUCCH Format 0/1 or PUCCH Format 2/3/4, among other definitions of PUCCH formats (e.g., newly defined PUCCH formats, dedicated scheduling request PUCCH formats).

In some examples, the formats may include one or more greater than two-bit (e.g., three or more bit) scheduling request formats. For example, a third format may include X bits of a multi-bit scheduling request that may represent a scheduling request type and an additional bit of the scheduling request that may represent a priority of the scheduling request. In some cases, a bitmap of the scheduling request type may be pre-defined at the UE 115-a, or pre-configured at the UE 115-a (e.g., by RRC or other signaling, in the message 230, in a previous message). There may be up to 2^{X} scheduling request types that may be pre-defined or pre-configured. Additionally, or alternatively, the UE 115-a may report up to one type of scheduling request using the third format.

In some examples, a fourth format may include Y bits of a multi-bit scheduling request that may represent a scheduling request index and an additional bit that may represent a priority of the scheduling request. In some cases, a bitmap of the scheduling request index may be pre-defined or pre-configured (e.g., by RRC or other signaling, in the message 230, in a previous message). Further, the scheduling request types and scheduling request indexes may be indicated in a same message, or in separate messages. Additionally, or alternatively, there may be up to 2^{Y} scheduling request indexes that may be pre-configured at the UE 115-a, and the UE 115-a may report up to one scheduling request index using the fourth format.

In some examples, a fifth format may involve N single-bit high-priority scheduling requests and an M-bit low-priority scheduling request. For example, the message 230 may include a total of N+M bits, where the N bits may indicate N high-priority scheduling requests (e.g., each bit of the N bits corresponding to each high-priority scheduling request) while the M bits may indicate a low-priority scheduling request (e.g., a bit combination may correspond to a type or instance of a low-priority scheduling request). In a representative example, where N=3 and M=2, corresponding bit combinations may be represented by Table 1.

TABLE 1

| | N single-bit high-priority | M-bit low-priority |
|---|---|---|
| | scheduling request | scheduling request |
| No scheduling request | 0 0 0 | 0 0 |
| High-priority 1 | 1 0 0 | 0 0 |
| High-priority 2 + | 0 1 1 | 0 0 |
| High-priority 3 | | |
| High-priority 3 + | 0 0 1 | 0 1 |
| Low-priority 1 | | |
| Low-priority 3 | 0 0 0 | 1 1 |
| . . . | . . . | . . . |

As illustrated in Table 1, a bit combination of “0, 0, 0” (high priority scheduling requests) and “0, 0” (low priority scheduling request) may indicate no scheduling requests. Additionally, or alternatively, a bit combination of “1, 0, 0” and “0, 0” may indicate a first type of high-priority scheduling request, a bit combination of “0, 1, 1” and “0, 0” may indicate both a second and a third type of high-priority scheduling requests, a bit combination of “0, 0, 1” and “0, 1” may indicate a third type of high-priority scheduling request and a first type of low-priority scheduling request, and a bit combination of “0, 0, 0” and “1, 1” may indicate a third type of low-priority scheduling request, etc. In some examples, there may be up to N high-priority scheduling requests and 2^{M-1} low-priority scheduling requests. Additionally, or alternatively, the UE 115-a may report up to N types of high-priority scheduling requests and one type of low-priority scheduling request at a time using the fifth format. Additionally, or alternatively, one or more bits may indicate multiple low-priority scheduling requests.

A sixth format may include a compressed method similar to the fifth format. For example, the sixth format may include a log₂(N+2^{M})-bit scheduling request with log₂(N+2^{M}) bits. In some examples, the quantity of bits may be based on a first quantity of bits N for indicating one or more high-priority scheduling requests and a second quantity of bits M for one or more low-priority scheduling requests. In some cases, the UE 115-a may report up to one type of scheduling request using the sixth format. Further, a bitmap or a table may be pre-defined or pre-configured at the UE 115-a (e.g., via RRC, MAC-CE, or another message) to define the various bit combinations of the third, fourth, fifth, and sixth formats. In some examples, the UE 115-a may report one or more scheduling requests according to the third format, the fourth format, the fifth format, and the sixth format using PUCCH Format 2/3/4, among other definitions of PUCCH formats (e.g., newly defined PUCCH formats, dedicated scheduling request PUCCH formats).

Additionally, or alternatively, the message 230, according to the formats described herein, may include bits representative of any quantity of high-priority and low-priority scheduling requests or scheduling request types. Further, the message 225 may indicate any quantity or combination of high-priority and low-priority scheduling requests or scheduling request types. Further, multiple high-priority or low-priority scheduling requests of the same type may be indicated by the message 230 (e.g., the bits may correspond to different scheduling requests of the same type). Further, bit combinations for any of the formats may consider alternative bit combinations or representations. Further, each of the first format through the sixth format described herein may be implemented separately, together, or features of one or more of the formats may be used in any combination. The formats may in some examples correspond to (e.g., defined for, configured for, selected to be used for) different types of scheduling requests, or may be shared across all scheduling request types. Additionally, or alternatively, the resources, scheduling request formats (e.g., formats, associated bitmaps, indexes, or other mappings), and scheduling request types, may be configured dynamically. For example, the network entity 105-a may transmit one or more dynamic messages to dynamically configure formats or resources, or change a format selection.

In some examples, the wireless communications system 200 may map different types or priorities of scheduling requests to different scheduling request configurations. For example, the network entity 105-a may transmit separate configurations for different types of scheduling requests in the message 230, where scheduling request types may vary based on associated programs or use (for example, scheduling requests transmitted in response to a beam failure recovery (BFR) procedure, scheduling requests transmitted for uplink or downlink data communications, etc.). The network entity 105-a may also hard partition scheduling request resources based on the separate configurations. In some examples, hard partitioning may result in low efficient use of PUCCH resources, for example, as the UE 115-a may wait until a specific transmission occasion (e.g., occasion 215, occasion 220) associated with a respective type of scheduling request for transmission, even if earlier transmission occasions configured for other types of scheduling requests are available. Low efficiency may prevent the network from configuring additional scheduling request occasions, resulting in longer scheduling request latency. Further, unreliable scheduling request transmission may cause scheduling request failure and may trigger RACH, further slowing operations.

In some examples, the wireless communications system 200 may implement a single unified scheduling request configuration to mitigate low efficiency and longer latency in scheduling requests. For example, the UE 115-a may receive a single unified scheduling request configuration for multiple scheduling request types in the message 225, and may use a multi-bit PUCCH format according to the configuration to indicate the trigger of a scheduling request. Additionally, or alternatively, the message may indicate a combination of resources for one or multiple types of scheduling requests. In some cases, a scheduling request configuration may be adaptive, where an adaptive scheduling request configuration may enable more efficient use of resources (e.g., PUCCH resources). Further, the wireless communications system 200 may implement one or more power control procedures for more reliable scheduling request transmission.

In some examples, the features described herein may improve communications within the wireless communications system 200. For example, utilizing a scheduling request format to enable differentiation between high-priority or low-priority scheduling requests may remove ambiguity in the scenario that a high-priority scheduling request is transmitted during a multi-bit occasion. Removal of such ambiguity may improve efficiency in communications and use of scheduling request resources by enabling a network entity 105-a to implement a high-priority scheduling strategy for high-priority scheduling requests, and may mitigate latency. Additionally, or alternatively, using the formats described herein may enable the indication of multiple different types of high-priority or low-priority scheduling requests in a same transmission occasion or message, reducing overhead. The sixth format may also further reduce overhead compared to the fifth format. Further, using a unified scheduling request configuration may reduce overhead in configuration messages, reduce a chance of failed messages, while also allowing reporting of different types of scheduling requests using the same resources to increase efficiency and reduce latency in communications. In some cases, using a unified configuration may enable use of more frequent scheduling request resources (e.g., PUCCH occasions) at a UE, reducing an amount of time to obtain an uplink grant. Further, without increasing a total amount of PUCCH resources per UE 115, the more efficiently scheduling request resources are used in accordance with the features described herein, the more likely a network may configure more scheduling request resources for a UE, such as the UE 115-a, resulting in shorter scheduling request latency. Further, using an adaptive scheduling request configuration may enable more efficient use of scheduling request resources, while implementing power control may result in more reliable scheduling request transmissions.

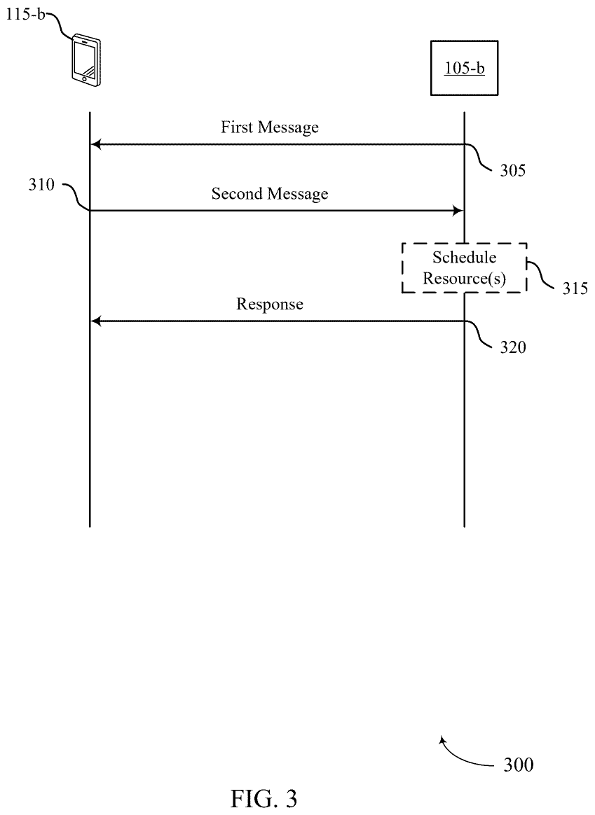

FIG. 3 shows an example of a process flow 300 that supports scheduling request formats in multi-bit transmission occasions in accordance with one or more aspects of the present disclosure. The process flow 300 may implement or be implemented at or using one or more aspects of the wireless communications systems 100 and 200. For example, the process flow 300 may be implemented by one or more UEs 115, including a UE 115-b, and one or more network entities, including a network entity 105-b, which may be examples of corresponding devices described with reference to FIGS. 1 and 2. In some examples, the one or more UEs 115 and network entities 105 may support different scheduling request formats as described herein.

In the following description of the process flow 300, the operations may be performed (such as reported or provided) in a different order than the order shown, or the operations performed by the example devices may be performed in different orders or at different times. Some operations also may be omitted from the process flow 300, or other operations may be added to the process flow 300. Further, although some operations or signaling may be shown to occur at different times for discussion purposes, these operations may actually occur at the same time or at least partially concurrently.

At 305, the UE 115-b may receive, and the network entity 105-b may output (e.g., transmit directly, transmit via one or more components of the network entity 105-b or via one or more components in communication with the network entity 105-b) a first message indicating a first set of multiple resources and a second set of multiple resources. In some examples, the message may indicate one or more formats for one or more different types of scheduling requests for one or more UEs 115, such as for the UE 115-b. Additionally, or alternatively, the first set of multiple resources may include single-bit resources associated with high-priority scheduling requests and the second set of multiple resources may include multi-bit resources associated with both low-priority scheduling requests and high-priority scheduling requests. In some cases, the network entity 105-b may output the first message to multiple UEs 115.

At 310, the UE 115-b may transmit, and the network entity may obtain (e.g., receive directly, receive via one or more components of the network entity 105-b or via one or more components in communication with the network entity 105-b), a second message indicating one or more scheduling requests over a multi-bit resource of the second set of multiple resources in accordance with a format of the one or more formats. In some examples, the format may indicate whether the one or more scheduling requests include a high-priority scheduling request.

In some examples, the second message may include two bits transmitted over the multi-bit resource in accordance with the format (e.g., the first format or the second format). In some cases, at least one of the two bits may indicate whether the second message includes a high-priority scheduling request. For example, the second message may include a first bit indicating whether the one or more scheduling requests include a high-priority scheduling request and a second bit indicating whether the one or more scheduling requests include a low-priority scheduling request. In some examples, the second message may include a first bit indicating a presence of a scheduling request and a second bit indicating a priority of the scheduling request.

In some examples, the second message may include three or more bits two bits transmitted over the multi-bit resource in accordance with the format (e.g., one of the third through sixth formats). In some examples, at least one of the three or more bits may indicate whether the second message includes a high-priority scheduling request. For example, the second message may include a quantity of bits indicating a type of a scheduling request and an additional bit indicating a priority of the scheduling request. Additionally, or alternatively, the second message may include a quantity of bits indicating an index associated with a scheduling request and an additional bit indicating a priority of the scheduling request. In some cases, a mapping for a set of multiple indexes including the index and a set of multiple scheduling requests including the scheduling request may be configured at the UE or may be received (or operable to be output) via the first message (e.g., via a same RRC or message as the resources) or via a third message (e.g., via a separate message).

In some examples, the second message may include a first quantity of bits indicating one or more high-priority scheduling requests and a second quantity of bits indicating one or more low-priority scheduling requests. Additionally, or alternatively, the second message may include a quantity of bits indicating a type of a scheduling request, where the quantity of bits may be based on a first quantity of bits for indicating one or more high-priority scheduling requests and a second quantity of bits for one or more low-priority scheduling requests.

At 315, the network entity 105-b may optionally schedule a third set of multiple resources for use in accordance with the one or more scheduling requests, where the response may indicate the third set of multiple resources.

At 320, the UE 115-b may receive, and the network entity may output, a response to the one or more scheduling requests. In some examples, the response may indicate the third set of multiple resources scheduled for use in accordance with the one or more scheduling requests.

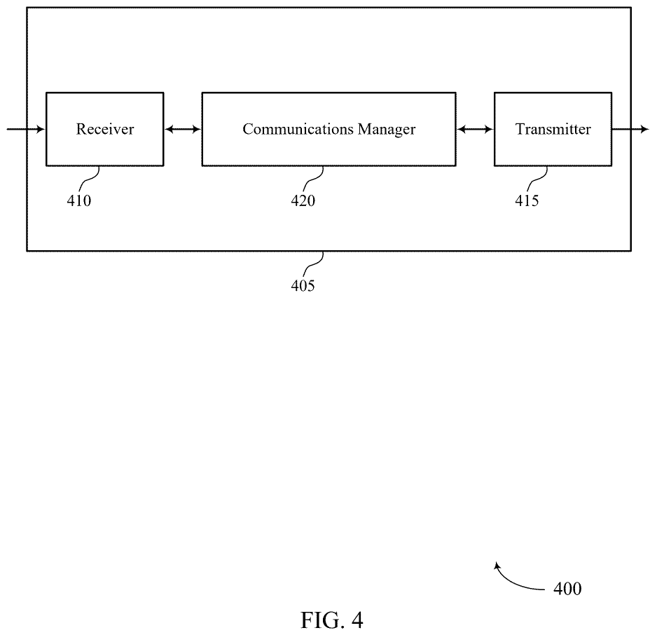

FIG. 4 shows a block diagram 400 of a device 405 that supports scheduling request formats in multi-bit transmission occasions in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to scheduling request formats in multi-bit transmission occasions). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to scheduling request formats in multi-bit transmission occasions). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of scheduling request formats in multi-bit transmission occasions as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software) executed (e.g., directly, indirectly, after pre-processing, without pre-processing) by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests. The communications manager 420 is capable of, configured to, or operable to support a means for transmitting a second message indicating one or more scheduling requests over a multi-bit resource of the second set of multiple resources in accordance with a format of the one or more formats, the format indicating whether the one or more scheduling requests include a high-priority scheduling request. The communications manager 420 is capable of, configured to, or operable to support a means for receiving a response to the one or more scheduling requests.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources by using scheduling requests formats to enable one or more devices to differentiate between high-priority and low-priority scheduling requests in communications.

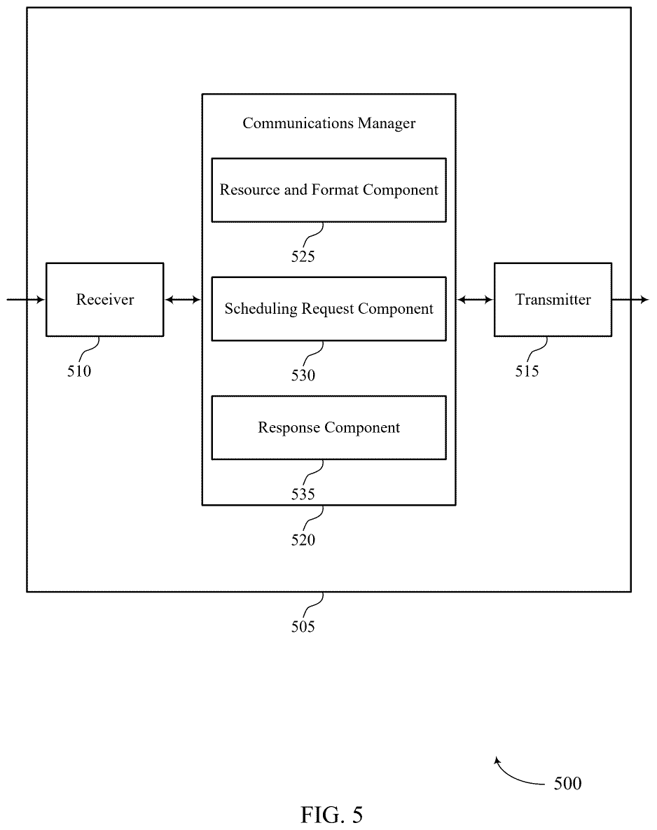

FIG. 5 shows a block diagram 500 of a device 505 that supports scheduling request formats in multi-bit transmission occasions in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to scheduling request formats in multi-bit transmission occasions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to scheduling request formats in multi-bit transmission occasions). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of scheduling request formats in multi-bit transmission occasions as described herein. For example, the communications manager 520 may include a resource and format component 525, a scheduling request component 530, a response component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The resource and format component 525 is capable of, configured to, or operable to support a means for receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests. The scheduling request component 530 is capable of, configured to, or operable to support a means for transmitting a second message indicating one or more scheduling requests over a multi-bit resource of the second set of multiple resources in accordance with a format of the one or more formats, the format indicating whether the one or more scheduling requests include a high-priority scheduling request. The response component 535 is capable of, configured to, or operable to support a means for receiving a response to the one or more scheduling requests.

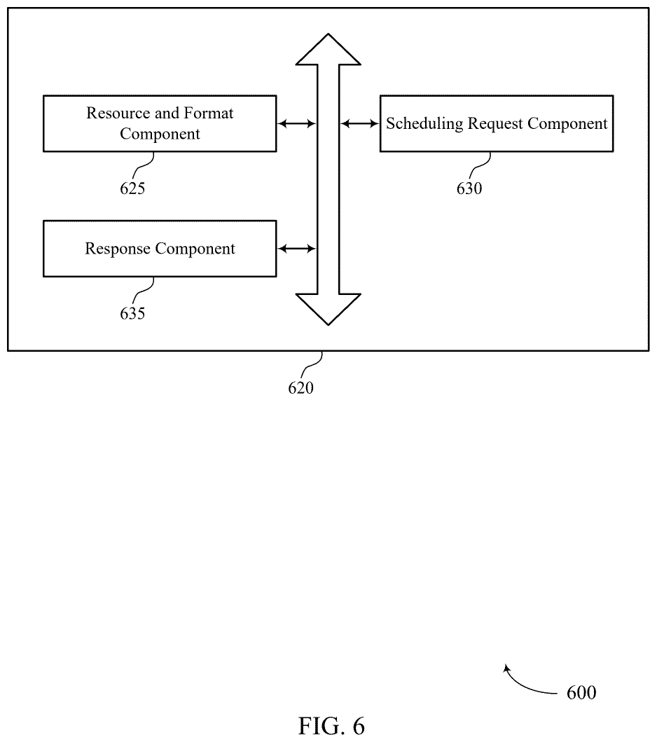

FIG. 6 shows a block diagram 600 of a communications manager 620 that supports scheduling request formats in multi-bit transmission occasions in accordance with one or more aspects of the present disclosure. The communications manager 620 may be an example of aspects of a communications manager 420, a communications manager 520, or both, as described herein. The communications manager 620, or various components thereof, may be an example of means for performing various aspects of scheduling request formats in multi-bit transmission occasions as described herein. For example, the communications manager 620 may include a resource and format component 625, a scheduling request component 630, a response component 635, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The resource and format component 625 is capable of, configured to, or operable to support a means for receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests. The scheduling request component 630 is capable of, configured to, or operable to support a means for transmitting a second message indicating one or more scheduling requests over a multi-bit resource of the second set of multiple resources in accordance with a format of the one or more formats, the format indicating whether the one or more scheduling requests include a high-priority scheduling request. The response component 635 is capable of, configured to, or operable to support a means for receiving a response to the one or more scheduling requests.

In some examples, to support transmitting a second message, the scheduling request component 630 is capable of, configured to, or operable to support a means for transmitting the second message including two bits over the multi-bit resource in accordance with the format of the one or more formats, where at least one of the two bits indicates whether the second message includes a high-priority scheduling request.

In some examples, the second message includes a first bit indicating whether the one or more scheduling requests include a high-priority scheduling request and a second bit indicating whether the one or more scheduling requests include a low-priority scheduling request.

In some examples, the second message includes a first bit indicating a presence of a scheduling request and a second bit indicating a priority of the scheduling request.

In some examples, to support transmitting a second message, the scheduling request component 630 is capable of, configured to, or operable to support a means for transmitting the second message including three or more bits, where at least one of the three or more bits indicates whether the second message includes a high-priority scheduling request.

In some examples, the second message includes a quantity of bits indicating a type of a scheduling request and an additional bit indicating a priority of the scheduling request.

In some examples, the second message includes a quantity of bits indicating an index associated with a scheduling request and an additional bit indicating a priority of the scheduling request. In some examples, a mapping for a set of multiple indexes including the index and a set of multiple scheduling requests including the scheduling request is configured at the UE or is received via the first message or via a third message.

In some examples, the second message includes a first quantity of bits indicating one or more high-priority scheduling requests and a second quantity of bits indicating one or more low-priority scheduling requests.

In some examples, the second message includes a quantity of bits indicating a type of a scheduling request. In some examples, the quantity of bits is based on a first quantity of bits for indicating one or more high-priority scheduling requests and a second quantity of bits for one or more low-priority scheduling requests.

In some examples, the response indicates a third set of multiple resources scheduled for use in accordance with the one or more scheduling requests.

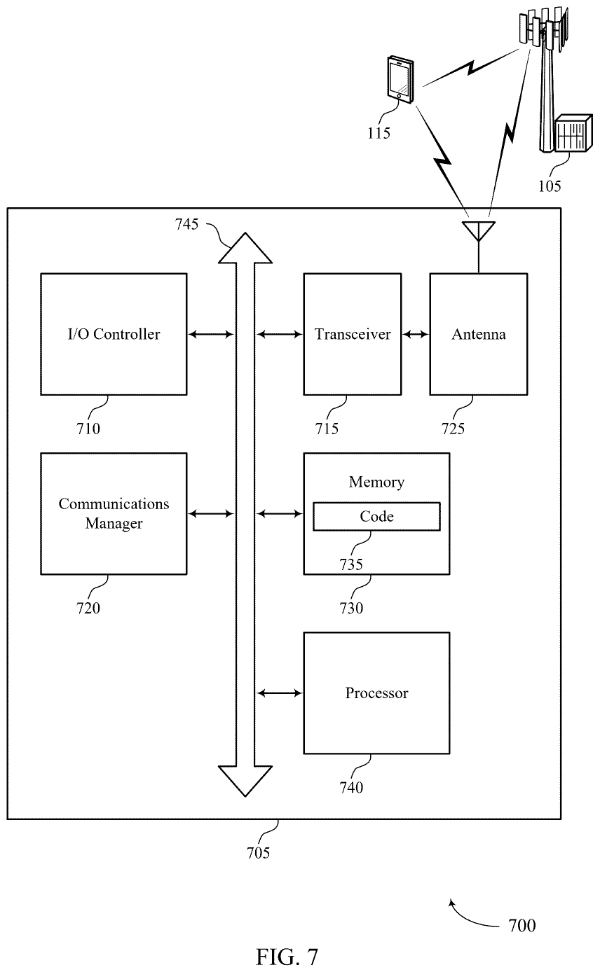

FIG. 7 shows a diagram of a system 700 including a device 705 that supports scheduling request formats in multi-bit transmission occasions in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting scheduling request formats in multi-bit transmission occasions). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests. The communications manager 720 is capable of, configured to, or operable to support a means for transmitting a second message indicating one or more scheduling requests over a multi-bit resource of the second set of multiple resources in accordance with a format of the one or more formats, the format indicating whether the one or more scheduling requests include a high-priority scheduling request. The communications manager 720 is capable of, configured to, or operable to support a means for receiving a response to the one or more scheduling requests.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, and improved utilization of processing capability by using scheduling requests formats to enable one or more devices to differentiate between high-priority and low-priority scheduling requests in communications.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of scheduling request formats in multi-bit transmission occasions as described herein, or the at least one processor 740 and the at least one memory 730 may be otherwise configured to, individually or collectively, perform or support such operations.

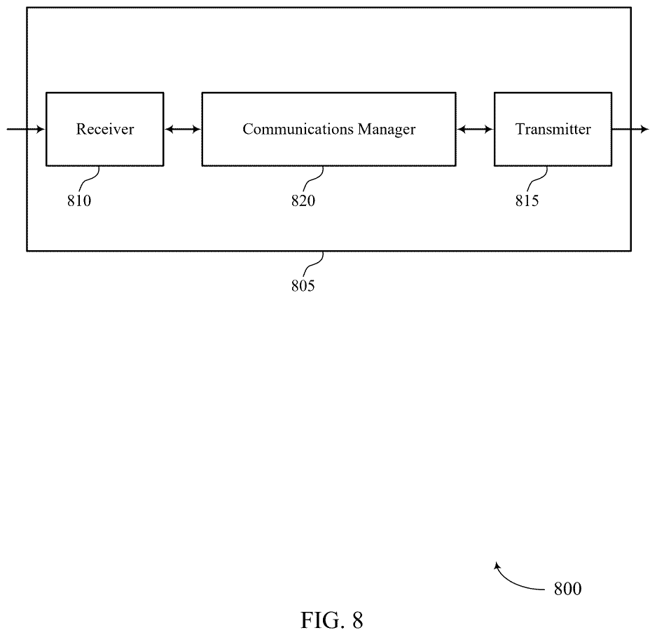

FIG. 8 shows a block diagram 800 of a device 805 that supports scheduling request formats in multi-bit transmission occasions in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of scheduling request formats in multi-bit transmission occasions as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software) executed (e.g., directly, indirectly, after pre-processing, without pre-processing) by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting a first message indicating a first set of multiple resources and a second set of multiple resources and indicating one or more formats for one or more different types of scheduling requests for one or more UEs, the first set of multiple resources including single-bit resources associated with high-priority scheduling requests and the second set of multiple resources including multi-bit resources associated with both low-priority scheduling requests and high-priority scheduling requests. The communications manager 820 is capable of, configured to, or operable to support a means for obtaining a second message indicating one or more scheduling requests over a multi-bit resource of the second set of multiple resources in accordance with a format of the one or more formats, the format indicating whether the one or more scheduling requests include a high-priority scheduling request. The communications manager 820 is capable of, configured to, or operable to support a means for outputting a response to the one or more scheduling requests.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources by using scheduling requests formats to enable one or more devices to differentiate between high-priority and low-priority scheduling requests in communications.

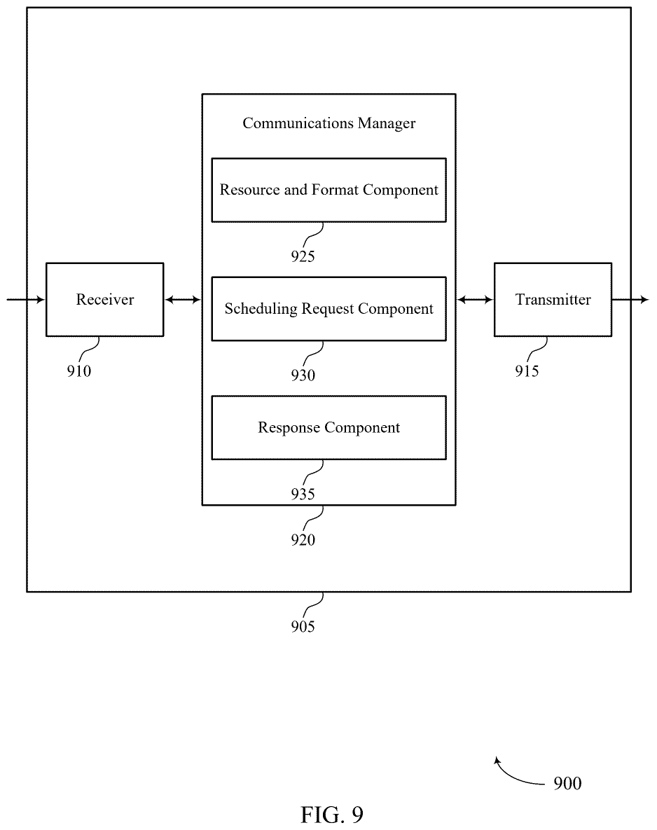

FIG. 9 shows a block diagram 900 of a device 905 that supports scheduling request formats in multi-bit transmission occasions in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of scheduling request formats in multi-bit transmission occasions as described herein. For example, the communications manager 920 may include a resource and format component 925, a scheduling request component 930, a response component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The resource and format component 925 is capable of, configured to, or operable to support a means for outputting a first message indicating a first set of multiple resources and a second set of multiple resources and indicating one or more formats for one or more different types of scheduling requests for one or more UEs, the first set of multiple resources including single-bit resources associated with high-priority scheduling requests and the second set of multiple resources including multi-bit resources associated with both low-priority scheduling requests and high-priority scheduling requests. The scheduling request component 930 is capable of, configured to, or operable to support a means for obtaining a second message indicating one or more scheduling requests over a multi-bit resource of the second set of multiple resources in accordance with a format of the one or more formats, the format indicating whether the one or more scheduling requests include a high-priority scheduling request. The response component 935 is capable of, configured to, or operable to support a means for outputting a response to the one or more scheduling requests.

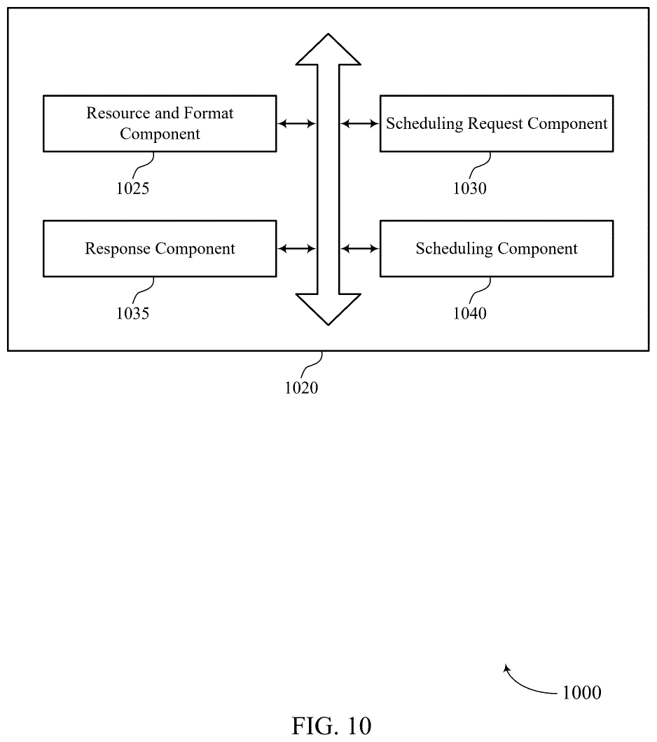

FIG. 10 shows a block diagram 1000 of a communications manager 1020 that supports scheduling request formats in multi-bit transmission occasions in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of scheduling request formats in multi-bit transmission occasions as described herein. For example, the communications manager 1020 may include a resource and format component 1025, a scheduling request component 1030, a response component 1035, a scheduling component 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The resource and format component 1025 is capable of, configured to, or operable to support a means for outputting a first message indicating a first set of multiple resources and a second set of multiple resources and indicating one or more formats for one or more different types of scheduling requests for one or more UEs, the first set of multiple resources including single-bit resources associated with high-priority scheduling requests and the second set of multiple resources including multi-bit resources associated with both low-priority scheduling requests and high-priority scheduling requests. The scheduling request component 1030 is capable of, configured to, or operable to support a means for obtaining a second message indicating one or more scheduling requests over a multi-bit resource of the second set of multiple resources in accordance with a format of the one or more formats, the format indicating whether the one or more scheduling requests include a high-priority scheduling request. The response component 1035 is capable of, configured to, or operable to support a means for outputting a response to the one or more scheduling requests.

In some examples, to support obtaining a second message, the scheduling request component 1030 is capable of, configured to, or operable to support a means for obtaining the second message including two bits over the multi-bit resource in accordance with the format of the one or more formats, where at least one of the two bits indicates whether the second message includes a high-priority scheduling request.

In some examples, the second message includes a first bit indicating whether the one or more scheduling requests include a high-priority scheduling request and a second bit indicating whether the one or more scheduling requests include a low-priority scheduling request.

In some examples, the second message includes a first bit indicating a presence of a scheduling request and a second bit indicating a priority of the scheduling request.

In some examples, to support obtaining a second message, the scheduling request component 1030 is capable of, configured to, or operable to support a means for obtaining the second message including three or more bits, where at least one of the three or more bits indicates whether the second message includes a high-priority scheduling request.

In some examples, the second message includes a quantity of bits indicating a type of a scheduling request and an additional bit indicating a priority of the scheduling request.

In some examples, the second message includes a quantity of bits indicating an index associated with a scheduling request and an additional bit indicating a priority of the scheduling request. In some examples, a mapping for a set of multiple indexes including the index and a set of multiple scheduling requests including the scheduling request is operable to be output via the first message or via a third message.

In some examples, the second message includes a first quantity of bits indicating one or more high-priority scheduling requests and a second quantity of bits indicating one or more low-priority scheduling requests.

In some examples, the second message includes a quantity of bits indicating a type of a scheduling request. In some examples, the quantity of bits is based on a first quantity of bits for indicating one or more high-priority scheduling requests and a second quantity of bits for one or more low-priority scheduling requests.

In some examples, the scheduling component 1040 is capable of, configured to, or operable to support a means for scheduling a third set of multiple resources for use in accordance with the one or more scheduling requests, where the response indicates the third set of multiple resources.

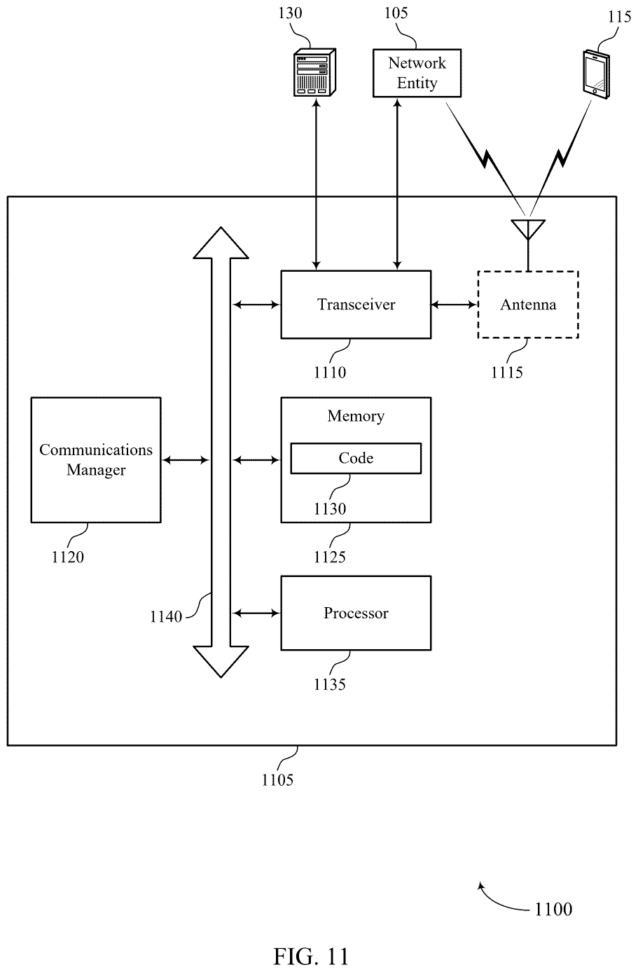

FIG. 11 shows a diagram of a system 1100 including a device 1105 that supports scheduling request formats in multi-bit transmission occasions in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting scheduling request formats in multi-bit transmission occasions). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting a first message indicating a first set of multiple resources and a second set of multiple resources and indicating one or more formats for one or more different types of scheduling requests for one or more UEs, the first set of multiple resources including single-bit resources associated with high-priority scheduling requests and the second set of multiple resources including multi-bit resources associated with both low-priority scheduling requests and high-priority scheduling requests. The communications manager 1120 is capable of, configured to, or operable to support a means for obtaining a second message indicating one or more scheduling requests over a multi-bit resource of the second set of multiple resources in accordance with a format of the one or more formats, the format indicating whether the one or more scheduling requests include a high-priority scheduling request. The communications manager 1120 is capable of, configured to, or operable to support a means for outputting a response to the one or more scheduling requests.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability by using scheduling requests formats to enable one or more devices to differentiate between high-priority and low-priority scheduling requests in communications.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of scheduling request formats in multi-bit transmission occasions as described herein, or the at least one processor 1135 and the at least one memory 1125 may be otherwise configured to, individually or collectively, perform or support such operations.

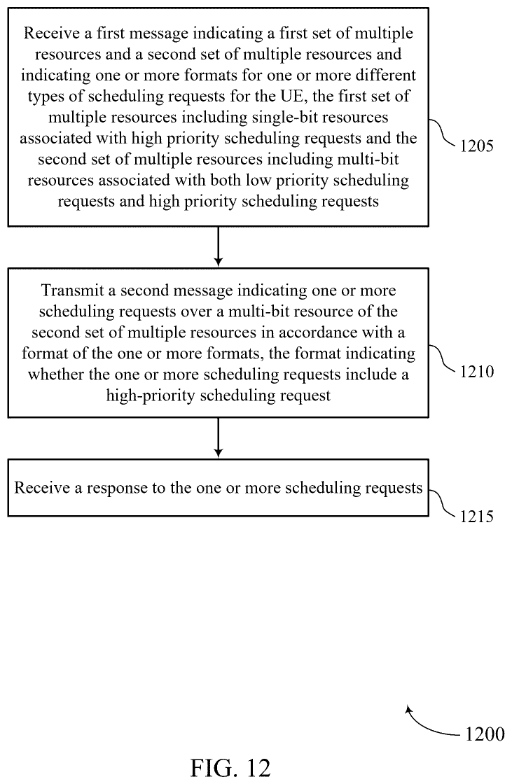

FIG. 12 shows a flowchart illustrating a method 1200 that supports scheduling request formats in multi-bit transmission occasions in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests. The operations of 1205 may be performed in accordance with examples as disclosed herein. In some examples, aspects of the operations of 1205 may be performed by a resource and format component 625 as described with reference to FIG. 6.

At 1210, the method may include transmitting a second message indicating one or more scheduling requests over a multi-bit resource of the second set of multiple resources in accordance with a format of the one or more formats, the format indicating whether the one or more scheduling requests include a high-priority scheduling request. The operations of 1210 may be performed in accordance with examples as disclosed herein. In some examples, aspects of the operations of 1210 may be performed by a scheduling request component 630 as described with reference to FIG. 6.

At 1215, the method may include receiving a response to the one or more scheduling requests. The operations of 1215 may be performed in accordance with examples as disclosed herein. In some examples, aspects of the operations of 1215 may be performed by a response component 635 as described with reference to FIG. 6.

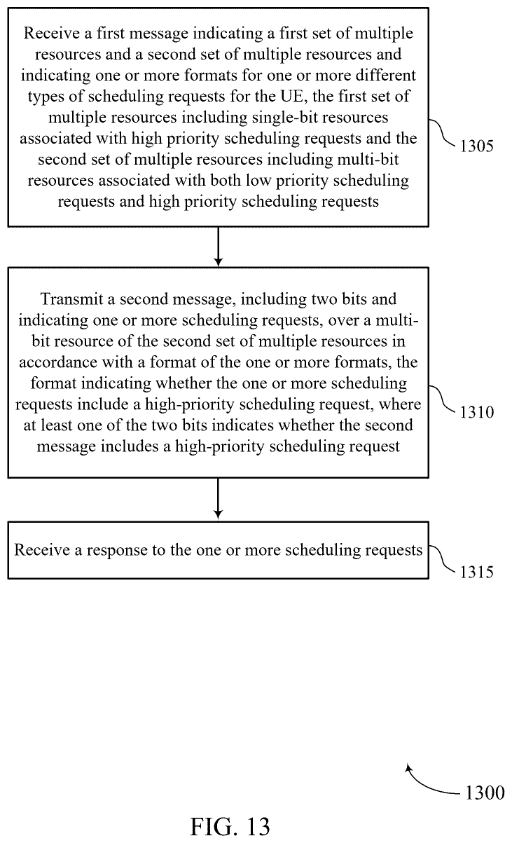

FIG. 13 shows a flowchart illustrating a method 1300 that supports scheduling request formats in multi-bit transmission occasions in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests. The operations of 1305 may be performed in accordance with examples as disclosed herein. In some examples, aspects of the operations of 1305 may be performed by a resource and format component 625 as described with reference to FIG. 6.

At 1310, the method may include transmitting a second message, including two bits and indicating one or more scheduling requests, over a multi-bit resource of the second set of multiple resources in accordance with a format of the one or more formats, the format indicating whether the one or more scheduling requests include a high-priority scheduling request, where at least one of the two bits indicates whether the second message includes a high-priority scheduling request. The operations of 1310 may be performed in accordance with examples as disclosed herein. In some examples, aspects of the operations of 1310 may be performed by a scheduling request component 630 as described with reference to FIG. 6.

At 1315, the method may include receiving a response to the one or more scheduling requests. The operations of 1315 may be performed in accordance with examples as disclosed herein. In some examples, aspects of the operations of 1315 may be performed by a response component 635 as described with reference to FIG. 6.

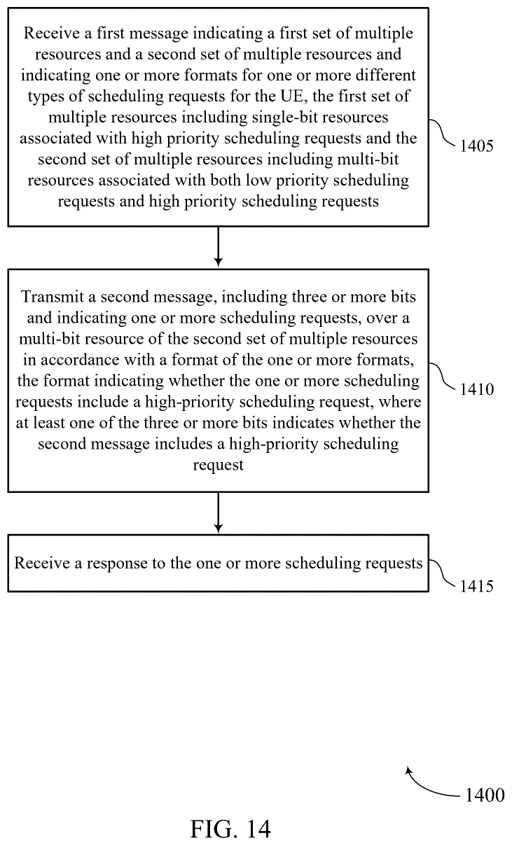

FIG. 14 shows a flowchart illustrating a method 1400 that supports scheduling request formats in multi-bit transmission occasions in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving a first message indicating a first set of multiple resources and a second set of multiple resources and indicating one or more formats for one or more different types of scheduling requests for the UE, the first set of multiple resources including single-bit resources associated with high-priority scheduling requests and the second set of multiple resources including multi-bit resources associated with both low-priority scheduling requests and high-priority scheduling requests. The operations of 1405 may be performed in accordance with examples as disclosed herein. In some examples, aspects of the operations of 1405 may be performed by a resource and format component 625 as described with reference to FIG. 6.

At 1410, the method may include transmitting a second message, including three or more bits and indicating one or more scheduling requests, over a multi-bit resource of the second set of multiple resources in accordance with a format of the one or more formats, the format indicating whether the one or more scheduling requests include a high-priority scheduling request, where at least one of the three or more bits indicates whether the second message includes a high-priority scheduling request. The operations of 1410 may be performed in accordance with examples as disclosed herein. In some examples, aspects of the operations of 1410 may be performed by a scheduling request component 630 as described with reference to FIG. 6.

At 1415, the method may include receiving a response to the one or more scheduling requests. The operations of 1415 may be performed in accordance with examples as disclosed herein. In some examples, aspects of the operations of 1415 may be performed by a response component 635 as described with reference to FIG. 6.

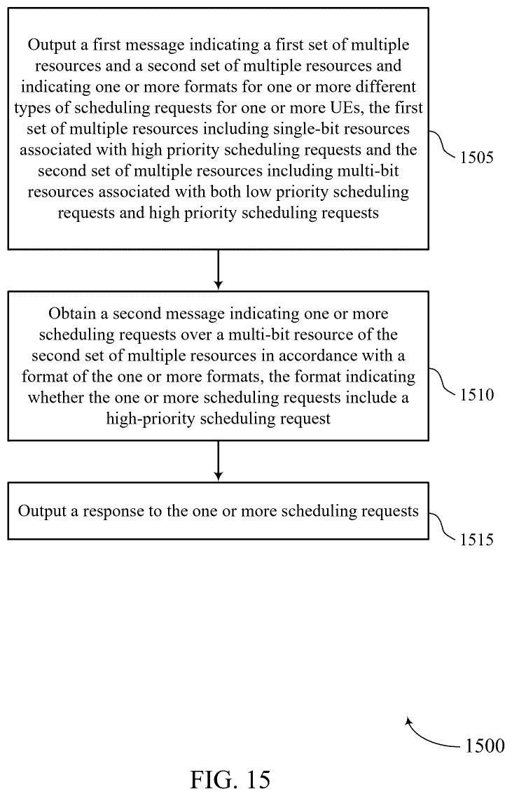

FIG. 15 shows a flowchart illustrating a method 1500 that supports scheduling request formats in multi-bit transmission occasions in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting a first message indicating a first set of multiple resources and a second set of multiple resources and indicating one or more formats for one or more different types of scheduling requests for one or more UEs, the first set of multiple resources including single-bit resources associated with high-priority scheduling requests and the second set of multiple resources including multi-bit resources associated with both low-priority scheduling requests and high-priority scheduling requests. The operations of 1505 may be performed in accordance with examples as disclosed herein. In some examples, aspects of the operations of 1505 may be performed by a resource and format component 1025 as described with reference to FIG. 10.

At 1510, the method may include obtaining a second message indicating one or more scheduling requests over a multi-bit resource of the second set of multiple resources in accordance with a format of the one or more formats, the format indicating whether the one or more scheduling requests include a high-priority scheduling request. The operations of 1510 may be performed in accordance with examples as disclosed herein. In some examples, aspects of the operations of 1510 may be performed by a scheduling request component 1030 as described with reference to FIG. 10.

At 1515, the method may include outputting a response to the one or more scheduling requests. The operations of 1515 may be performed in accordance with examples as disclosed herein. In some examples, aspects of the operations of 1515 may be performed by a response component 1035 as described with reference to FIG. 10.

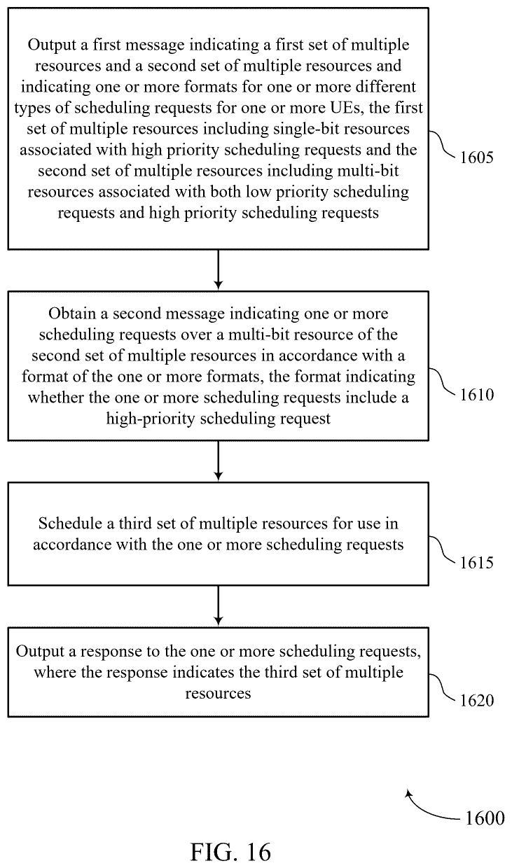

FIG. 16 shows a flowchart illustrating a method 1600 that supports scheduling request formats in multi-bit transmission occasions in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include outputting a first message indicating a first set of multiple resources and a second set of multiple resources and indicating one or more formats for one or more different types of scheduling requests for one or more UEs, the first set of multiple resources including single-bit resources associated with high-priority scheduling requests and the second set of multiple resources including multi-bit resources associated with both low-priority scheduling requests and high-priority scheduling requests. The operations of 1605 may be performed in accordance with examples as disclosed herein. In some examples, aspects of the operations of 1605 may be performed by a resource and format component 1025 as described with reference to FIG. 10.

At 1610, the method may include obtaining a second message indicating one or more scheduling requests over a multi-bit resource of the second set of multiple resources in accordance with a format of the one or more formats, the format indicating whether the one or more scheduling requests include a high-priority scheduling request. The operations of 1610 may be performed in accordance with examples as disclosed herein. In some examples, aspects of the operations of 1610 may be performed by a scheduling request component 1030 as described with reference to FIG. 10.

At 1615, the method may include scheduling a third set of multiple resources for use in accordance with the one or more scheduling requests. The operations of 1615 may be performed in accordance with examples as disclosed herein. In some examples, aspects of the operations of 1615 may be performed by a scheduling component 1040 as described with reference to FIG. 10.

At 1620, the method may include outputting a response to the one or more scheduling requests, where the response indicates the third set of multiple resources. The operations of 1620 may be performed in accordance with examples as disclosed herein. In some examples, aspects of the operations of 1620 may be performed by a response component 1035 as described with reference to FIG. 10.

The following provides an overview of aspects of the present disclosure:
Aspect 1: A method for wireless communications at a UE, comprising: receiving a first message indicating a first plurality of resources and a second plurality of resources and indicating one or more formats for one or more different types of scheduling requests for the UE, the first plurality of resources comprising single-bit resources associated with high-priority scheduling requests and the second plurality of resources comprising multi-bit resources associated with both low-priority scheduling requests and high-priority scheduling requests; transmitting a second message indicating one or more scheduling requests over a multi-bit resource of the second plurality of resources in accordance with a format of the one or more formats, the format indicating whether the one or more scheduling requests comprise a high-priority scheduling request; and receiving a response to the one or more scheduling requests.
Aspect 2: The method of aspect 1, wherein transmitting a second message comprises: transmitting the second message comprising two bits over the multi-bit resource in accordance with the format of the one or more formats, wherein at least one of the two bits indicates whether the second message comprises a high-priority scheduling request.
Aspect 3: The method of aspect 2, wherein the second message comprises: a first bit indicating whether the one or more scheduling requests comprise a high-priority scheduling request; and a second bit indicating whether the one or more scheduling requests comprise a low-priority scheduling request.
Aspect 4: The method of any of aspects 2 through 3, wherein the second message comprises: a first bit indicating a presence of a scheduling request; and a second bit indicating a priority of the scheduling request.
Aspect 5: The method of any of aspects 1 through 4, wherein transmitting a second message comprises: transmitting the second message comprising three or more bits, wherein at least one of the three or more bits indicates whether the second message comprises a high-priority scheduling request.
Aspect 6: The method of aspect 5, wherein the second message comprises: a quantity of bits indicating a type of a scheduling request; and an additional bit indicating a priority of the scheduling request.
Aspect 7: The method of any of aspects 5 through 6, wherein the second message comprises: a quantity of bits indicating an index associated with a scheduling request, wherein a mapping for a plurality of indexes comprising the index and a plurality of scheduling requests comprising the scheduling request is configured at the UE or is received via the first message or via a third message; and an additional bit indicating a priority of the scheduling request.
Aspect 8: The method of any of aspects 5 through 7, wherein the second message comprises: a first quantity of bits indicating one or more high-priority scheduling requests; and a second quantity of bits indicating one or more low-priority scheduling requests.
Aspect 9: The method of any of aspects 5 through 8, wherein the second message comprises: a quantity of bits indicating a type of a scheduling request, wherein the quantity of bits is based at least in part on a first quantity of bits for indicating one or more high-priority scheduling requests and a second quantity of bits for one or more low-priority scheduling requests.
Aspect 10: The method of any of aspects 1 through 9, wherein the response indicates a third plurality of resources scheduled for use in accordance with the one or more scheduling requests.
Aspect 11: A method for wireless communications at a network entity, comprising: outputting a first message indicating a first plurality of resources and a second plurality of resources and indicating one or more formats for one or more different types of scheduling requests for one or more user equipments (UEs), the first plurality of resources comprising single-bit resources associated with high-priority scheduling requests and the second plurality of resources comprising multi-bit resources associated with both low-priority scheduling requests and high-priority scheduling requests; obtaining a second message indicating one or more scheduling requests over a multi-bit resource of the second plurality of resources in accordance with a format of the one or more formats, the format indicating whether the one or more scheduling requests comprise a high-priority scheduling request; and outputting a response to the one or more scheduling requests.
Aspect 12: The method of aspect 11, wherein obtaining a second message comprises: obtaining the second message comprising two bits over the multi-bit resource in accordance with the format of the one or more formats, wherein at least one of the two bits indicates whether the second message comprises a high-priority scheduling request.
Aspect 13: The method of aspect 12, wherein the second message comprises: a first bit indicating whether the one or more scheduling requests comprise a high-priority scheduling request; and a second bit indicating whether the one or more scheduling requests comprise a low-priority scheduling request.
Aspect 14: The method of any of aspects 12 through 13, wherein the second message comprises: a first bit indicating a presence of a scheduling request; and a second bit indicating a priority of the scheduling request.
Aspect 15: The method of any of aspects 11 through 14, wherein obtaining a second message comprises: obtaining the second message comprising three or more bits, wherein at least one of the three or more bits indicates whether the second message comprises a high-priority scheduling request.
Aspect 16: The method of aspect 15, wherein the second message comprises: a quantity of bits indicating a type of a scheduling request; and an additional bit indicating a priority of the scheduling request.
Aspect 17: The method of any of aspects 15 through 16, wherein the second message comprises: a quantity of bits indicating an index associated with a scheduling request, wherein a mapping for a plurality of indexes comprising the index and a plurality of scheduling requests comprising the scheduling request is operable to be output via the first message or via a third message; and an additional bit indicating a priority of the scheduling request.
Aspect 18: The method of any of aspects 15 through 17, wherein the second message comprises: a first quantity of bits indicating one or more high-priority scheduling requests; and a second quantity of bits indicating one or more low-priority scheduling requests.
Aspect 19: The method of any of aspects 15 through 18, wherein the second message comprises: a quantity of bits indicating a type of a scheduling request, wherein the quantity of bits is based at least in part on a first quantity of bits for indicating one or more high-priority scheduling requests and a second quantity of bits for one or more low-priority scheduling requests.
Aspect 20: The method of any of aspects 11 through 19, further comprising: scheduling a third plurality of resources for use in accordance with the one or more scheduling requests, wherein the response indicates the third plurality of resources.
Aspect 21: A UE for wireless communications, comprising one or more memories storing processor-executable code, and one or more processors coupled with the one or more memories and individually or collectively operable to execute the code to cause the UE to perform a method of any of aspects 1 through 10.
Aspect 22: A UE for wireless communications, comprising at least one means for performing a method of any of aspects 1 through 10.
Aspect 23: A non-transitory computer-readable medium storing code for wireless communications, the code comprising instructions executable by one or more processors to perform a method of any of aspects 1 through 10.
Aspect 24: A network entity for wireless communications, comprising one or more memories storing processor-executable code, and one or more processors coupled with the one or more memories and individually or collectively operable to execute the code to cause the network entity to perform a method of any of aspects 11 through 20.
Aspect 25: A network entity for wireless communications, comprising at least one means for performing a method of any of aspects 11 through 20.
Aspect 26: A non-transitory computer-readable medium storing code for wireless communications, the code comprising instructions executable by one or more processors to perform a method of any of aspects 11 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message indicating a first plurality of resources and a second plurality of resources and indicating one or more formats for one or more different types of scheduling requests for the UE, the first plurality of resources comprising single-bit resources associated with high-priority scheduling requests and the second plurality of resources comprising multi-bit resources associated with both low-priority scheduling requests and high-priority scheduling requests;
transmit a second message indicating one or more scheduling requests over a multi-bit resource of the second plurality of resources in accordance with a format of the one or more formats, the format indicating whether the one or more scheduling requests comprise a high-priority scheduling request; and
receive a response to the one or more scheduling requests.

2. The UE of claim 1, wherein, to transmit a second message, the one or more processors are individually or collectively operable to execute the code to cause the UE to:
transmit the second message comprising two bits over the multi-bit resource in accordance with the format of the one or more formats, wherein at least one of the two bits indicates whether the second message comprises a high-priority scheduling request.

3. The UE of claim 2, wherein the second message comprises:
a first bit indicating whether the one or more scheduling requests comprise a high-priority scheduling request; and
a second bit indicating whether the one or more scheduling requests comprise a low-priority scheduling request.

4. The UE of claim 2, wherein the second message comprises:
a first bit indicating a presence of a scheduling request; and
a second bit indicating a priority of the scheduling request.

5. The UE of claim 1, wherein, to transmit a second message, the one or more processors are individually or collectively operable to execute the code to cause the UE to:
transmit the second message comprising three or more bits, wherein at least one of the three or more bits indicates whether the second message comprises a high-priority scheduling request.

6. The UE of claim 5, wherein the second message comprises:
a quantity of bits indicating a type of a scheduling request; and
an additional bit indicating a priority of the scheduling request.

7. The UE of claim 5, wherein the second message comprises:
a quantity of bits indicating an index associated with a scheduling request, wherein a mapping for a plurality of indexes comprising the index and a plurality of scheduling requests comprising the scheduling request is configured at the UE or is received via the first message or via a third message; and
an additional bit indicating a priority of the scheduling request.

8. The UE of claim 5, wherein the second message comprises:
a first quantity of bits indicating one or more high-priority scheduling requests; and
a second quantity of bits indicating one or more low-priority scheduling requests.

9. The UE of claim 5, wherein the second message comprises:
a quantity of bits indicating a type of a scheduling request, wherein the quantity of bits is based at least in part on a first quantity of bits for indicating one or more high-priority scheduling requests and a second quantity of bits for one or more low-priority scheduling requests.

10. The UE of claim 1, wherein the response indicates a third plurality of resources scheduled for use in accordance with the one or more scheduling requests.

11. A network entity, comprising:
one or more memories storing processor-executable code; and
one or more processors coupled with the one or more memories and individually or collectively operable to execute the code to cause the network entity to:
output a first message indicating a first plurality of resources and a second plurality of resources and indicating one or more formats for one or more different types of scheduling requests for one or more user equipments (UEs), the first plurality of resources comprising single-bit resources associated with high-priority scheduling requests and the second plurality of resources comprising multi-bit resources associated with both low-priority scheduling requests and high-priority scheduling requests;
obtain a second message indicating one or more scheduling requests over a multi-bit resource of the second plurality of resources in accordance with a format of the one or more formats, the format indicating whether the one or more scheduling requests comprise a high-priority scheduling request; and
output a response to the one or more scheduling requests.

12. The network entity of claim 11, wherein, to obtain a second message, the one or more processors are individually or collectively operable to execute the code to cause the network entity to:
obtain the second message comprising two bits over the multi-bit resource in accordance with the format of the one or more formats, wherein at least one of the two bits indicates whether the second message comprises a high-priority scheduling request.

13. The network entity of claim 12, wherein the second message comprises:
a first bit indicating whether the one or more scheduling requests comprise a high-priority scheduling request; and
a second bit indicating whether the one or more scheduling requests comprise a low-priority scheduling request.

14. The network entity of claim 12, wherein the second message comprises:
a first bit indicating a presence of a scheduling request; and
a second bit indicating a priority of the scheduling request.

15. The network entity of claim 11, wherein, to obtain a second message, the one or more processors are individually or collectively operable to execute the code to cause the network entity to:
obtain the second message comprising three or more bits, wherein at least one of the three or more bits indicates whether the second message comprises a high-priority scheduling request.

16. The network entity of claim 15, wherein the second message comprises:
a quantity of bits indicating a type of a scheduling request; and
an additional bit indicating a priority of the scheduling request.

17. The network entity of claim 15, wherein the second message comprises:
a quantity of bits indicating an index associated with a scheduling request, wherein a mapping for a plurality of indexes comprising the index and a plurality of scheduling requests comprising the scheduling request is operable to be output via the first message or via a third message; and
an additional bit indicating a priority of the scheduling request.

18. The network entity of claim 15, wherein the second message comprises:
a first quantity of bits indicating one or more high-priority scheduling requests; and
a second quantity of bits indicating one or more low-priority scheduling requests.

19. The network entity of claim 15, wherein the second message comprises:
a quantity of bits indicating a type of a scheduling request, wherein the quantity of bits is based at least in part on a first quantity of bits for indicating one or more high-priority scheduling requests and a second quantity of bits for one or more low-priority scheduling requests.

20. The network entity of claim 11, wherein the one or more processors are individually or collectively further operable to execute the code to cause the network entity to:
schedule a third plurality of resources for use in accordance with the one or more scheduling requests, wherein the response indicates the third plurality of resources.

21. A method for wireless communications at a user equipment (UE), comprising:
receiving a first message indicating a first plurality of resources and a second plurality of resources and indicating one or more formats for one or more different types of scheduling requests for the UE, the first plurality of resources comprising single-bit resources associated with high-priority scheduling requests and the second plurality of resources comprising multi-bit resources associated with both low-priority scheduling requests and high-priority scheduling requests;
transmitting a second message indicating one or more scheduling requests over a multi-bit resource of the second plurality of resources in accordance with a format of the one or more formats, the format indicating whether the one or more scheduling requests comprise a high-priority scheduling request; and
receiving a response to the one or more scheduling requests.

22. The method of claim 21, wherein transmitting a second message comprises:
transmitting the second message comprising two bits over the multi-bit resource in accordance with the format of the one or more formats, wherein at least one of the two bits indicates whether the second message comprises a high-priority scheduling request.

23. The method of claim 22, wherein the second message comprises:
a first bit indicating whether the one or more scheduling requests comprise a high-priority scheduling request; and
a second bit indicating whether the one or more scheduling requests comprise a low-priority scheduling request.

24. The method of claim 22, wherein the second message comprises:
a first bit indicating a presence of a scheduling request; and
a second bit indicating a priority of the scheduling request.

25. The method of claim 21, wherein transmitting a second message comprises:
transmitting the second message comprising three or more bits, wherein at least one of the three or more bits indicates whether the second message comprises a high-priority scheduling request.

26. The method of claim 21, wherein the response indicates a third plurality of resources scheduled for use in accordance with the one or more scheduling requests.

27. A method for wireless communications at a network entity, comprising:
outputting a first message indicating a first plurality of resources and a second plurality of resources and indicating one or more formats for one or more different types of scheduling requests for one or more user equipments (UEs), the first plurality of resources comprising single-bit resources associated with high-priority scheduling requests and the second plurality of resources comprising multi-bit resources associated with both low-priority scheduling requests and high-priority scheduling requests;
obtaining a second message indicating one or more scheduling requests over a multi-bit resource of the second plurality of resources in accordance with a format of the one or more formats, the format indicating whether the one or more scheduling requests comprise a high-priority scheduling request; and
outputting a response to the one or more scheduling requests.

28. The method of claim 27, wherein obtaining a second message comprises:
obtaining the second message comprising two bits over the multi-bit resource in accordance with the format of the one or more formats, wherein at least one of the two bits indicates whether the second message comprises a high-priority scheduling request.

29. The method of claim 27, wherein obtaining a second message comprises:
obtaining the second message comprising three or more bits, wherein at least one of the three or more bits indicates whether the second message comprises a high-priority scheduling request.

30. The method of claim 27, further comprising:
scheduling a third plurality of resources for use in accordance with the one or more scheduling requests, wherein the response indicates the third plurality of resources.
